(19) United States
(12) Patent Application Publication
(10) Pub. No.: US 2014/0214230 A1
(43) Pub. Date: Jul. 31, 2014

(54) SYSTEMS AND METHODS FOR MAXIMUM POWER POINT TRACKING IN A MICRO INVERTER

(71) Applicant: GENERAL ELECTRIC COMPANY, Schenectady, NY (US)

(72) Inventors: Vijay Dayaldas Gurudasani, Hyderabad (IN); Remesh Kumar Keeramthode, Secunderabad (IN); Jeyaprakash Kandasamy, Hyderabad (IN); N V S Kumar Srighakollapu, Hyderabad (IN); Rekha Kandiyil Raveendran, Hyderabad (IN)

(73) Assignee: General Electric Company, Schenectady, NY (US)

(21) Appl. No.: 13/751,765

(22) Filed: Jan. 28, 2013

(51) Int. Cl. G06F 1/26; H02J 3/00

(52) U.S. Cl. CPC G06F 1/26; H02J 3/00
USPC 700/297

(57) ABSTRACT

In one aspect, a method for operating a micro inverter using power point tracking is provided. The method includes calculating a change in input power over at least one previous grid cycle, calculating a change in an output current reference over the at least one previous grid cycle, and controlling the output current reference based on the change in input power over the at least one previous grid cycle and the change in the output current reference over the at least one previous grid cycle.

### BACKGROUND

The present application relates generally to operating a micro inverter, and more specifically, to operating the micro inverter using maximum power point tracking.

Sunlight is a potential source of renewable energy that is becoming increasingly attractive as an alternative source of energy. Solar energy in the form of irradiance may be converted to electrical energy using solar cells. A more general term for devices that convert light to electrical energy is “photovoltaic cells.” The electrical energy output of a photovoltaic (“PV”) cell is in the form of direct current (“DC”). In order for this DC output to be utilized by at least some conventional alternating current (“AC”) electronic devices, as well as the electric power grid, it must first be converted from DC to AC. Conventionally, this DC to AC conversion is performed with a power converter.

One type of solar power converter, a micro inverter, converts DC electricity from a single solar panel to AC. Conventionally, the electric power from several solar panels are combined and connected to a string or central inverter which is fed into an electrical distribution network, or “grid.” Micro inverters, in contrast with conventional string or central inverter devices, feed electric power from each solar panel to the electrical distribution network or grid.

At least some known micro inverters utilize maximum power point tracking to attempt to optimize the input power drawn from a solar panel. For example, at least some known maximum power point tracking techniques use a perturb and observe method, where an output current reference is adjusted, and it is determined whether the adjustment increased or decreased the input power. However, at least some known maximum power point tracking techniques are relatively inaccurate, and are unable to efficiently and dynamically track the maximum power point.

### BRIEF DESCRIPTION

In one aspect, a method for operating a micro inverter using power point tracking is provided. The method includes calculating a change in input power over at least one previous grid cycle, calculating a change in an output current reference over the at least one previous grid cycle, and controlling the output current reference based on the change in input power over the at least one previous grid cycle and the change in the output current reference over the at least one previous grid cycle.

In another aspect, a method for operating micro inverter using power point tracking is provided. The method includes calculating a total change in input power over a predetermined plurality of previous grid cycles, calculating a total change in input voltage over the predetermined plurality of previous grid cycles, and controlling an output current reference based on at least one of the total change in input power over the predetermined plurality of previous grid cycles and the total change in input voltage over the predetermined plurality of previous grid cycles.

In yet another aspect, a micro inverter is provided. The micro inverter includes a microcontroller configured to operate the micro inverter using power point tracking, and a memory communicatively coupled to the microcontroller and having computer-readable instructions stored thereon. The computer-readable instructions are executable by the microcontroller to instruct the microcontroller to calculate a change in input power over at least one previous grid cycle, calculate a change in an output current reference over the at least one previous grid cycle, and control the output current reference based on the change in input power over the at least one previous grid cycle and the change in the output current reference over the at least one previous grid cycle.

### BRIEF DESCRIPTION OF THE DRAWINGS

FIG. 1 is a schematic diagram of an exemplary power distribution system.

FIG. 2 is a schematic block diagram of an exemplary system for controlling a micro inverter that may be used with the power distribution system shown in FIG. 1.

FIG. 3 is a schematic diagram of an exemplary low power profile.

FIG. 4 is an oscillogram for a micro inverter operating in a continuous power mode with a low input power.

FIG. 5 is an oscillogram for a micro inverter operating in a discontinuous power mode with a low input power.

FIG. 6 is an exemplary flow diagram of the operation of a micro inverter.

FIG. 7 is an explanatory diagram for maximum power point tracking.

FIG. 8 is an exemplary flow diagram of the operation of a micro inverter using maximum power point tracking.

### DETAILED DESCRIPTION

Exemplary embodiments of operating a micro inverter using maximum power point tracking are described herein. For maximum power point tracking, a microcontroller controls an output current reference of the micro inverter. The output current reference may be incremented or decremented based on at least one of a change in input voltage from a previous grid cycle, a change in input power from a previous grid cycle, and a slope of a power output curve. The output current may be incremented or decremented by an MPPT step size that is set based on a change in input power from a previous grid cycle.

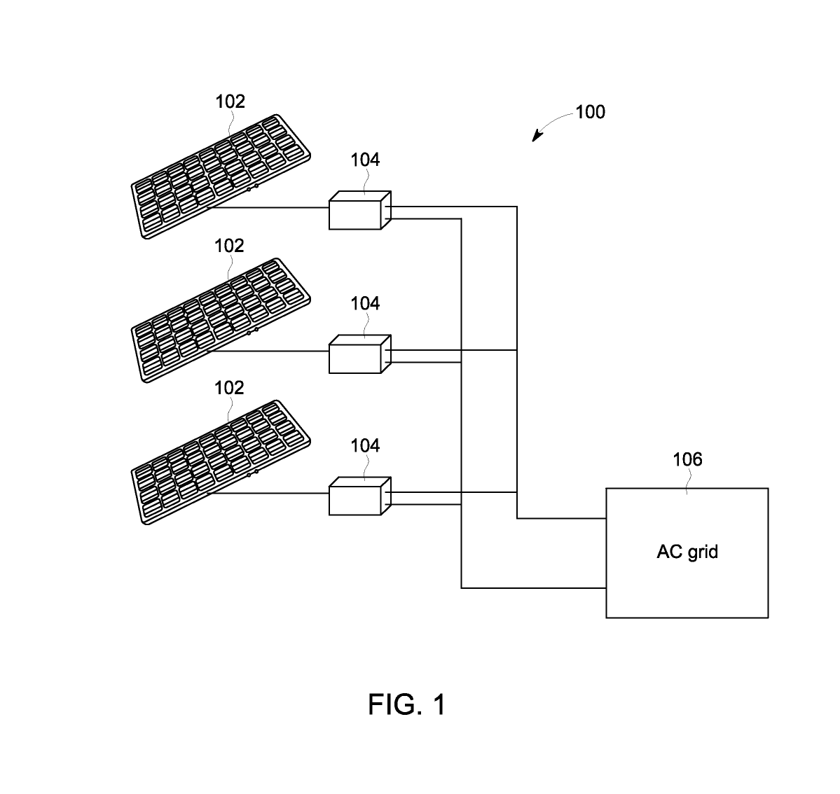

FIG. 1 is a schematic diagram of an exemplary power distribution system 100 that includes a plurality of solar panels 102 that convert energy received from sunlight into direct current (DC) power. In an exemplary embodiment, each solar panel 102 is coupled to a micro inverter 104 that converts the DC power from the associated solar panel 102 into alternating current (AC) power. The AC power is provided to an AC grid 106 to power one or more devices.

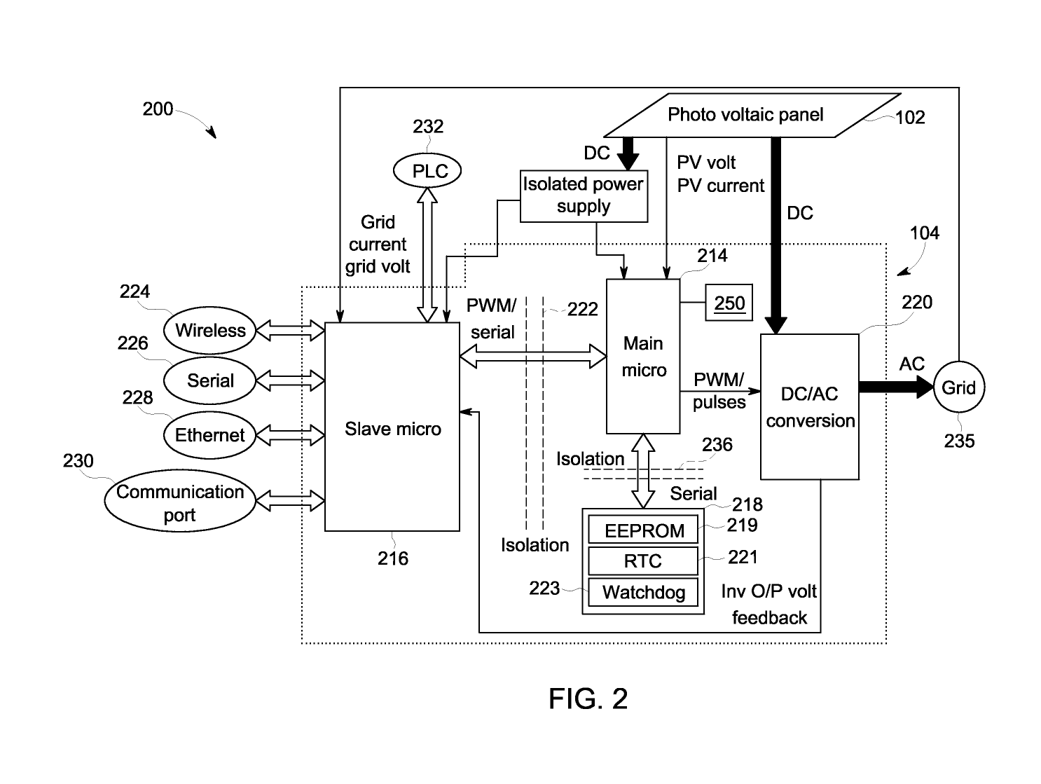

FIG. 2 is a schematic block diagram of an exemplary system 200 for controlling a micro inverter 104 coupled to a solar panel 102. System 200 may be used with power distribution system 100 (shown in FIG. 1). In an exemplary embodiment, solar panel 102 includes one or more of a photovoltaic (PV) panel or any other device that converts solar energy to electrical energy. As described above, in an exemplary embodiment, each solar panel 102 generates DC power as a result of solar energy striking solar panels 102.

In an exemplary embodiment, a primary microcontroller 214, a secondary microcontroller 216 and an external monitoring system 218 are all microcontrollers that include a processing device and a memory. The term “microcontroller,” as used herein, may refer to central processing units, microprocessors, microcontrollers, reduced instruction set circuits (RISC), application specific integrated circuits (ASIC), Digital Signal Processors (DSP), Field Programmable Logic Arrays (FPGA), logic circuits, and/or any other circuit or processor capable of executing the functions described herein. The above examples are exemplary only, and thus are not intended to limit in any way the definition and/or meaning of the term “microcontroller.”

A memory 219 stores program code and instructions, executable by processing device, to control and/or monitor various functions of micro inverter 104. In an exemplary embodiment, memory 219 is an electrically erasable programmable read only memory (EEPROM). Alternatively, memory 219 may be any suitable storage medium, including, but not limited to non-volatile RAM (NVRAM), magnetic RAM (MRAM), ferroelectric RAM (FeRAM), read only memory (ROM), and /or flash memory. Any other suitable magnetic, optical and/or semiconductor memory, by itself or in combination with other forms of memory, may be included in memory. Memory may also be, or include, a detachable or removable memory, including, but not limited to, a suitable cartridge, disk, CD ROM, DVD or USB memory.

According to an exemplary embodiment, micro inverter 104 includes primary microcontroller 214 configured to send a pulse width modulation (PWM) signal to a DC to AC conversion unit 220. In place of the PWM signal, any conversion signal suitable for enabling DC to AC conversion can be employed. The PWM signal is used to control the formation of an AC waveform from a DC form. Micro inverter 104 further includes a first isolator 222 and secondary microcontroller 216 communicatively coupled to primary microcontroller 214 via first isolator 222. Secondary microcontroller 216 may be configured to provide more than one communication mode to primary microcontroller 214 for communicating with a remote system (not shown). For example, secondary microcontroller 216 may provide data through wireless 224, serial 226, Ethernet 228, communication port 230, and/or power line carrier 232 communication modes. Secondary microcontroller 216 may also monitor instantaneous samples of grid voltage, grid current, and output voltage of micro inverter 104 and communicates the same feed parameters to primary microcontroller 214 for achieving grid synchronization and micro inverter 104 output current control using isolation through first isolator 222. In an alternative embodiment, a single microcontroller may replace the combination of primary microcontroller 214 and secondary microcontroller 216, performing all of the functions thereof.

Primary microcontroller 214 is configured to perform control operations in an exemplary embodiment including maximum power point tracking (MPPT), grid synchronization, anti-islanding, output current control, diagnostic monitoring and safety monitoring. Maximum power point tracking is a control method used to maximize a power output of solar panels 102. Grid synchronization is a function that facilitates matching the output of DC to AC conversion unit 220 to an electric grid 235, such as AC grid 106 (shown in FIG. 1). Anti-islanding functionality causes the independent sources to be disconnected from electric grid 235, when the utility power generator is disconnected from electric grid 235. Output current control functionality facilitates offloading desired output current magnitude and phase to grid 235 based on the maximum peak input power available from solar panel 102.

In an exemplary embodiment, first isolator 222 includes at least one of an optical isolator, an analog isolator, a digital isolator, a solid-state isolator device, and a high voltage protection circuit. An optical isolator is a device that employs light to convey signals from one endpoint to another, without providing direct electrical communication between endpoints. A digital isolator is a device that passes data and signals between endpoints by providing magnetic or capacitive coupling through an isolator channel. A solid-state isolator device is a semiconductor device that enables system to function as described herein. An analog isolator is a device that employs a magnetic field to convey signals from one endpoint to another, without providing direct electrical communication between endpoints. A high voltage protection circuit is any circuit that enables the passage of low voltage signals between two endpoints but suppresses high voltage signals from passing between the endpoints.

System 200 also includes a second isolator 236 and external monitoring system 218 coupled to primary microcontroller 214 via second isolator 236 in an exemplary embodiment. Second isolator 236 is, for example, at least one of an optical isolator, an analog isolator, a digital isolator, a solid-state isolator device and a high voltage protection circuit.

External monitoring system 218 is configured to store operating information from primary microcontroller 214 in memory 219. According to an exemplary embodiment, memory 219 is an EEPROM. Utilizing a real time clock 221 connected to memory 219, external monitoring system 218 can timestamp data retrieved from microcontroller 214 for use by technicians who may later evaluate the data.

According to an embodiment, external monitoring system 218 further includes a watchdog circuit 223 that monitors the state of primary microcontroller 214 and effectuates the restart of primary microcontroller 214 in the event that primary microcontroller 214 fails. Watchdog circuit 223 gives primary microcontroller 214 opportunities to restart without requiring outside intervention.

Memory 219 of external monitoring system 218 may be programmed with configuration information for primary microcontroller 214. For example, programmed configuration information can include settings such as which communications modes to enable in secondary microcontroller 216. The programmed configuration information can also include identifying unit information and node identification information for communications, so that a remote system can accurately identify one inverter from another. Memory 219 may also include computer-readable instructions and/or settings that control operation of micro inverter 104, as described in detail herein.

During power on, in an exemplary embodiment, primary microcontroller 214 retrieves operating information from external monitoring system 218 and provides a communication channel select command to secondary microcontroller 216 wherein the required communication channel is selected by secondary microcontroller 216 and the selected communication channel is provided to the primary microcontroller 214.

According to an exemplary embodiment, memory 219 of external monitoring system 218 is configured to store various inverter configurations, including a plurality of low power profiles, as described in detail below. External monitoring system 218 conducts a health check of solar panel 102 and determines the status of any connection to grid 235. Along with the status of grid connection, external monitoring system 218 measures a grid current and voltage and records a fault history of solar panel 102 including over-current shutdown faults, sun irradiation levels and reasons for the fault. External monitoring system 218 also records a total time for which the unit has generated power, a unit efficiency including cumulative efficiency and maximum efficiency and the time of the inverter's last low power mode. Further, monitoring system 218 records a time of the inverter's last day mode and an amount of total energy generation.

In an exemplary embodiment, micro inverter 104 has two modes of operation: a high power continuous mode (also referred to as a continuous power mode), and a low power discontinuous mode (also referred to as a discontinuous power mode). In an exemplary embodiment, primary microcontroller 214 controls operation of micro inverter 104, and switches operation between the high power continuous mode and the low power discontinuous mode based on an efficiency of micro inverter 104, as described in detail herein. Alternatively, any processing device and/or controller that enable micro inverter 104 to function as described herein may control operation of micro inverter 104. During the high power continuous mode, micro inverter 104 operates with maximum power point tracking (MPPT) enabled, and micro inverter 104 continuously provides output power (i.e., an output current and output voltage) to electric grid 235. With MPPT tracking enabled, primary microcontroller 214 tracks input power of micro inverter 104, and an inverter efficiency threshold detector 250 monitors the efficiency of micro inverter 104. In an exemplary embodiment, inverter efficiency threshold detector 250 is a separate component communicatively coupled to primary microcontroller 214. Alternatively, inverter efficiency threshold detector 250 may be part of primary microcontroller 214.

As used herein, the efficiency of micro inverter 104 is defined as the ratio of an output power of micro inverter 104 to an input power of micro inverter 104. When inverter efficiency threshold detector 250 detects that the efficiency has fallen below a threshold efficiency, primary microcontroller 214 causes micro inverter 104 to switch from the high power continuous mode to the low power discontinuous mode.

In an exemplary embodiment, inverter efficiency threshold detector 250 only monitors the efficiency of micro inverter 104 when the input power of micro inverter 104 is below a predetermined percentage of the rated input power of micro inverter 104. For example, inverter efficiency threshold detector 250 may only monitor the efficiency of micro inverter 104 if the input power is less than 50% of the rated input power of micro inverter 104. Accordingly, if the efficiency of micro inverter 104 is below the threshold efficiency, but the input power of micro inverter 104 is still above the predetermined percentage of the rated input power, micro inverter 104 will not switch to the low power discontinuous mode, but will continue to operate in the high power continuous mode. A low input power may occur, for example, due to low radiance (i.e., low levels of sunlight incident on solar panel 102.

In the low power discontinuous mode, in the exemplary embodiment, micro inverter 104 operates in accordance with a selected low power profile that provides a minimum fixed output current reference, and a fixed number of power ON and power OFF cycles, as described in detail herein. In an exemplary embodiment, a plurality of low power profiles are stored on memory 219. Alternatively, the low power profiles may be stored on any memory device accessible by primary microcontroller 214. In an exemplary embodiment, a low power profile is selected from the plurality of low power profiles based on the input power of micro inverter 104. Alternatively, a low power profile may be selected based on any criterion that enables micro inverter 104 to function as described herein.

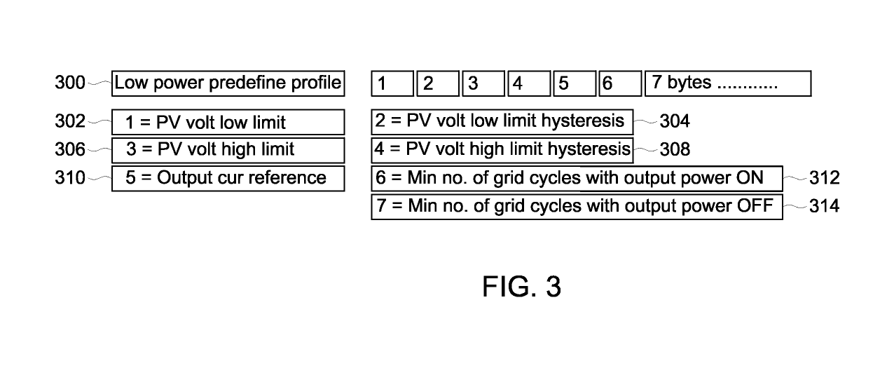

Each low power profile defines values for a plurality of operational parameters. FIG. 3 is a schematic diagram of an exemplary low power profile 300 stored on a memory device, such as memory 219 (shown in FIG. 2). As shown in FIG. 3, in an exemplary embodiment, each low power profile includes a PV volt low limit 302, a PV volt low limit hysteresis 304, a PV volt high limit 306, a PV volt high limit hysteresis 308, an output current reference 310, a fixed number of grid cycles with output power ON 312, and a fixed number of grid cycles with output power OFF 314, as described in detail herein. The fixed number of power ON and OFF cycles are stored as part of the low power profile and based on the PV input power, such that an average output power during the discontinuous power mode does not exceed the PV input power. In the exemplary embodiment, the output current reference may be adjusted to facilitate operating micro inverter 104 such that maximum power is extracted from the PV input power. Alternatively, each low power profile 300 may include any operational parameters that enable micro inverter 104 to function as described herein.

In the low power discontinuous mode, the output current reference 310 of the predetermined low power profile 300 points to a higher input power than the solar panel 102 is actually able to provide. This causes micro inverter 104 to supply discontinuous power to electric grid 235. Once the fixed number of power ON cycles as defined in the low power profile are delivered to the grid, micro inverter 104 is turned off for the fixed number of OFF power cycles, and this cycle is repeated as defined by the low power profile. Additionally, when the input voltage drops below PV volt low limit 302, as defined in low power profile 300, the inverter output will be turned off by primary microcontroller 214. When the input voltage rises above PV volt low limit hysteresis 304, as defined in low power profile 300, the inverter output will be turned back on by primary microcontroller 214.

Under certain conditions, primary microcontroller 214 will cause micro inverter 104 to exit the low power discontinuous mode micro inverter 104 will return to the high power continuous mode. For example, in an exemplary embodiment, a timeout occurs after a predefined number of cycles with the output power on have occurred (as defined by minimum number of grid cycles with output power on 312) or after a predefined number of cycles with the output power off have occurred (as defined by minimum number of grid cycles with output power off 314). When the timeout occurs, primary microcontroller 214 returns to operation in the high power continuous mode.

In an exemplary embodiment, the continuous power mode may be enabled when the input voltage and power of micro inverter 104 rises above respective threshold limits as defined in low power profile 300. Alternatively, the continuous power mode may also be enabled when other conditions occur that enable micro inverter 104 to function as described herein. For example, the continuous power mode may be enabled when the input power is greater than the predetermined percentage of the rated input power (e.g., 50%).

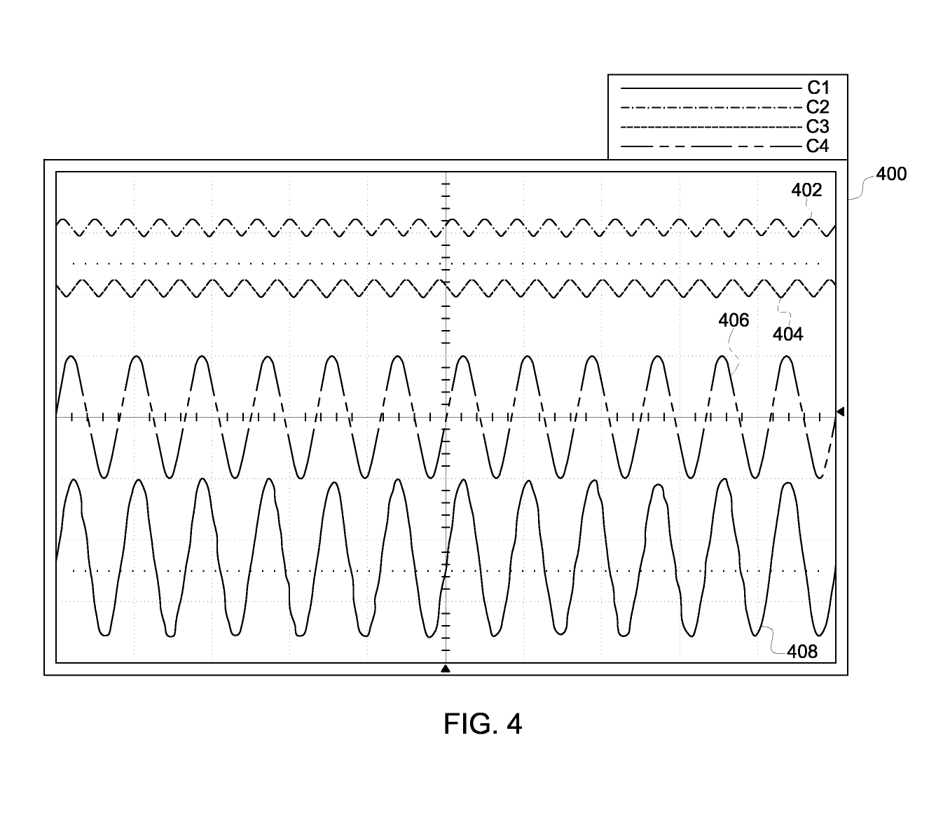

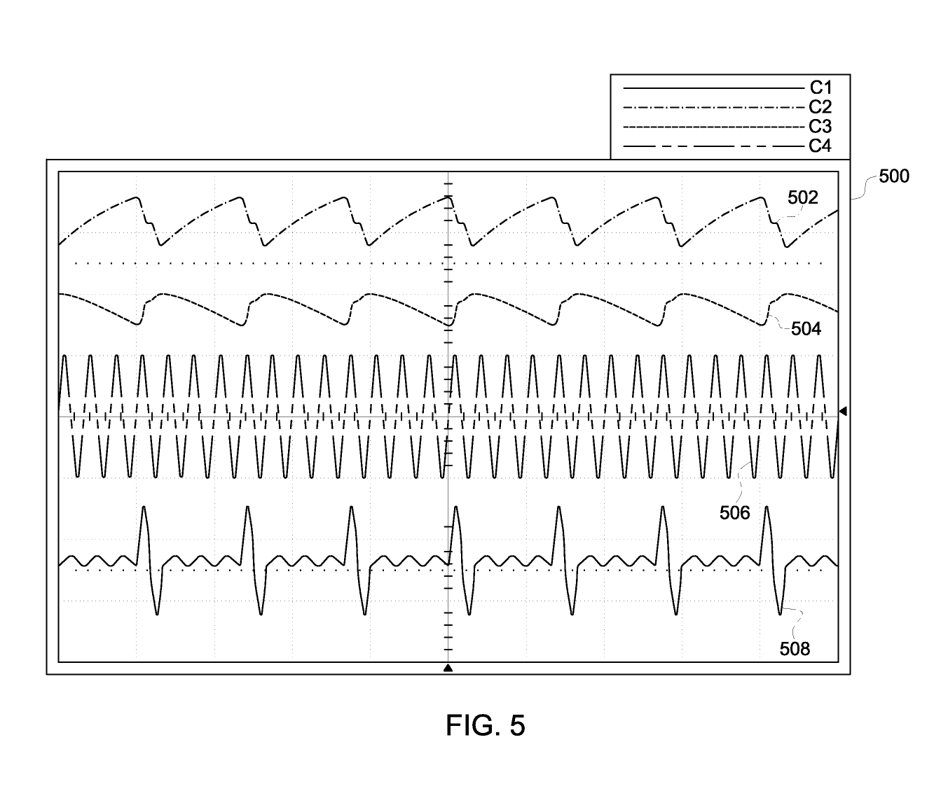

By switching to the low power discontinuous mode when the efficiency is below the threshold efficiency, the efficiency of micro inverter 104 is improved while still maintaining substantially the same average output power achieved in a continuous power mode, as described herein. FIG. 4 is an oscillogram 400 for micro inverter 104 operating in a continuous power mode with a low input power. In contrast, FIG. 5 is an oscillogram 500 for micro inverter 104 operating in a discontinuous power mode with a low input power (i.e., the low power discontinuous mode described herein).

Oscillogram 400 includes an input voltage trace 402, an input current trace 404, an output voltage trace 406, and an output current trace 408. As shown in FIG. 4, in a continuous power mode, micro inverter 104 continuously supplies AC output power.

Oscillogram 500 includes an input voltage trace 502, an input current trace 504, an output voltage trace 506, and an output current trace 508. As shown in FIG. 5, in a discontinuous power mode, micro inverter 104 alternates between supplying AC output power and not supplying any output power. Although AC output power is not output continuously in the discontinuous power mode, because of output current reference 310 of low power profile 300, when micro inverter 104 is supplying output power, it supplies more instantaneous output power than the continuous power mode. Accordingly, the average output powers in oscillogram 400 and oscillogram 500 are substantially equal, but the efficiency of micro inverter 104 for oscillogram 500 is higher than the efficiency for oscillogram 400.

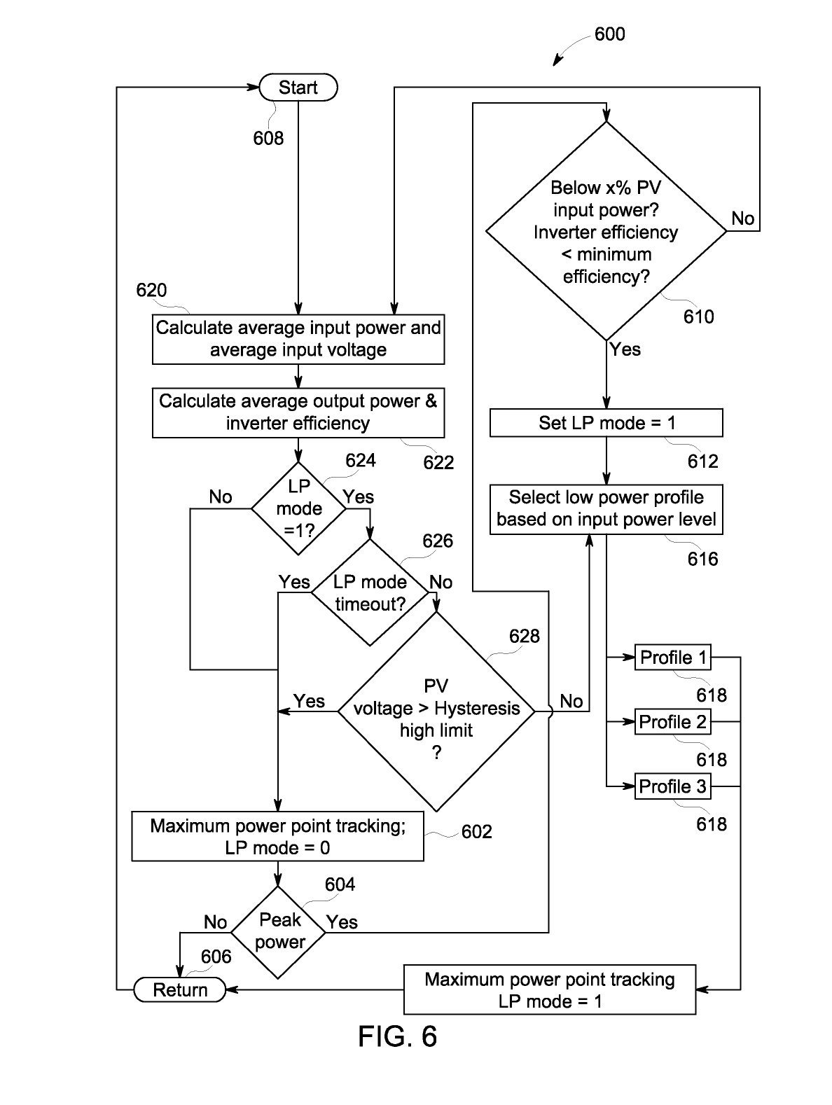

FIG. 6 is an exemplary flow diagram 600 of the operation of a micro inverter, such as micro inverter 104 (shown in FIG. 1). Unless otherwise indicated, in an exemplary embodiment, a processing device or microcontroller, such as primary microcontroller 214 (shown in FIG. 2) performs the steps and makes the determinations shown in flow diagram 600.

For purposes of explanation, assume the micro inverter starts operation at block 602, with MPPT enabled and the low power discontinuous mode is exited (shown as LP Mode=0 in FIG. 6). At block 604, using MPPT, it is determined whether the micro inverter is operating at a peak power. If the micro inverter is not operating at the peak power, the flow continues to block 606, which leads to micro inverter starting and carrying out one grid cycle at block 620.

If the micro inverter is operating at the peak power, at block 610, it is determined whether or not the micro inverter is operating below the predetermined percentage of the rated input power. If the micro inverter is operating below the predetermined percentage, it is determined (e.g., using inverter efficiency threshold detector 250 (shown in FIG. 2)) whether the efficiency of the micro inverter is below the threshold efficiency. If the micro inverter is operating below the predetermined percentage and the efficiency is below the threshold efficiency, the flow proceeds to block 612. Otherwise, the flow proceeds to block 620.

At block 612, micro inverter switches to the low power discontinuous mode (i.e., LP Mode=1), and at block 616, a predetermined low power profile, such as low power profile 300 (shown in FIG. 3), is selected from a plurality of profiles 618 based on the input power of the micro inverter. Once a low power profile is selected, the micro inverter operates in the low power discontinuous mode and the flow proceeds to block 606 to carry out one grid cycle at block 608.

At block 620, the average input voltage and average input power are calculated based on sampled input voltage and input current measurements over a single or multiple completed grid cycles, and an average output power and inverter efficiency are calculated at block 622.

At block 624, it is determined whether the micro inverter is currently operating in the low power discontinuous mode. If the micro inverter is not operating in the low power discontinuous mode, the flow proceeds to block 602. If the micro inverter is operating in the low power discontinuous mode, the flow proceeds to block 626.

At block 626, it is determined whether a timeout of the low power discontinuous mode has been reached. As explained above, in an exemplary embodiment, a timeout occurs after a predefined number of cycles with the output power on have occurred or after a predefined number of cycles with the output power off have occurred, as defined by the low power profile. If a timeout has occurred, the micro inverter exits the low power discontinuous mode and the MPPT is enabled at block 602. If a timeout has not occurred, the flow proceeds to block 628.

At block 628, it is determined whether the input voltage of the micro inverter is above the PV volt high limit hysteresis as defined in the low power profile. If the input voltage is above the PV volt high limit hysteresis, the micro inverter exits the low power discontinuous mode at block 602. If the input voltage is not above the PV volt high limit hysteresis, the flow proceeds to block 616.

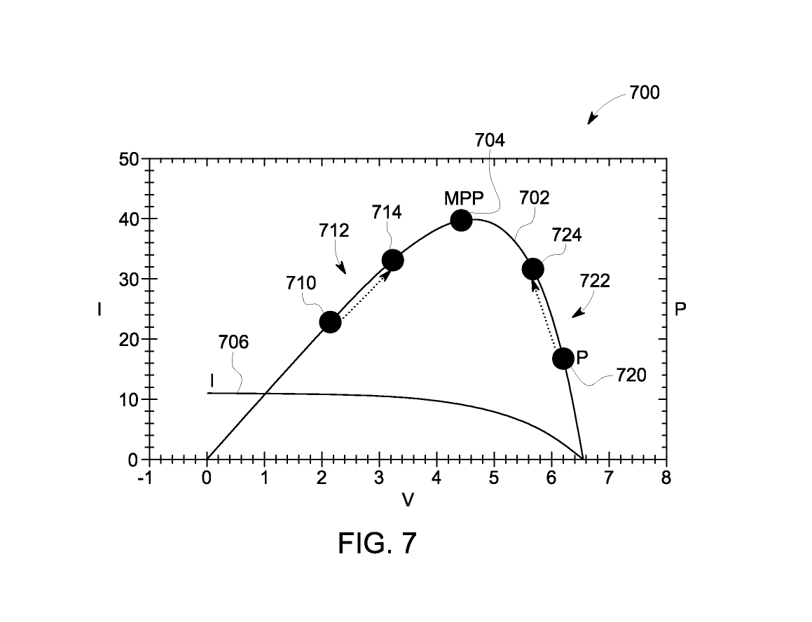

FIG. 7 is an explanatory diagram 700 for power point tracking, and more specifically, maximum power point tracking. In a micro inverter, such as micro inverter 104 (shown in FIG. 1), the input power of the micro inverter is defined by a non-linear relationship between the input current and the input voltage of the micro inverter. In FIG. 7, for example, an input power curve 702 is defined by the relationship between the input current and the input voltage. As shown in FIG. 7, input power curve 702 has a maximum value at a maximum power point 704. When operating the micro inverter, it is advantageous to operate as close to maximum power point 704 as possible, in order to maximize the input DC power that may be converted into output AC power.

Diagram 700 also includes an input current curve 706. By decreasing the input current, the operating point of the micro inverter moves left to right along the input power curve 702. By increasing the input current, the operating point of the micro inverter moves right to left along the input power curve 702. For a given root mean square of grid (i.e., output) voltage and PV input DC voltage, the average output current is proportional to the average input current. Hence, the average output power can be maximized by adjusting either grid-side output current or PV-side input current.

For example, if the micro inverter is operating at a first operating point 710 on a left side 712 of maximum power point 704 (i.e., to the left of maximum power point 704), a slope of input power curve 702 is positive. When operating on left side 712, in order to move closer to operating at maximum power point 704, the output current reference is decremented. That is, by decrementing the output current reference, the micro inverter shifts from operating at first operating point 710 to a second operating point 714.

If, however, the micro inverter is operating at a third operating point 720 on a right side 722 of maximum power point 704 (i.e., to the right of maximum power point 704), a slope of input power curve 702 is negative. When operating on right side 722, in order to move closer to operating at maximum power point 704, the output current reference is incremented. That is, by incrementing the output current reference, the micro inverter shifts from operating at third operating point 720 to a fourth operating point 724.

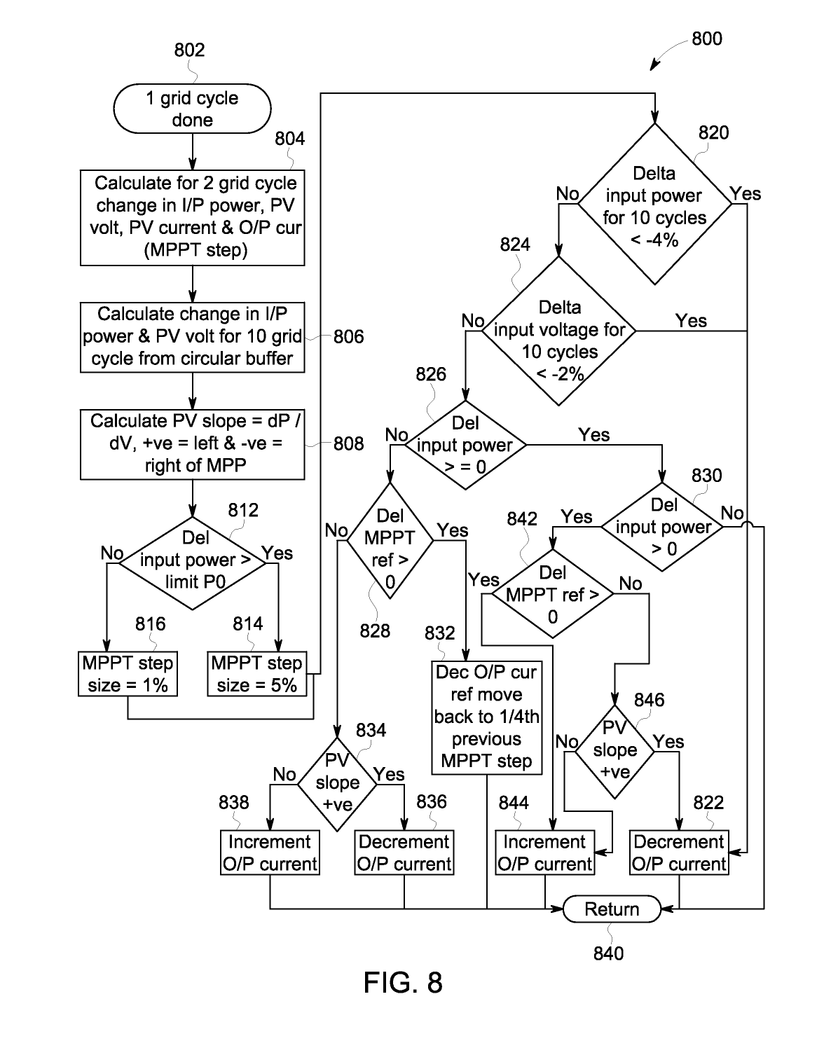

FIG. 8 is an exemplary flow diagram 800 of the operation of a micro inverter, such as micro inverter 104 (shown in FIG. 1), using maximum power point tracking (MPPT). Unless otherwise indicated, in an exemplary embodiment, a processing device or microcontroller, such as primary microcontroller 214 (shown in FIG. 2) performs the steps and makes the determinations shown in flow diagram 800. Computer-readable instructions for operating the micro inverter using MPPT are stored on a memory device communicatively coupled to the processing device or microcontroller, such as memory 219 (shown in FIG. 2). The memory device may be external to or within the processing device or microcontroller. In an exemplary embodiment, the processing device or microcontroller executes the computer-readable instructions from the memory device to identify predetermined settings used in an MPPT instruction routine to operate the micro inverter.

For MPPT, an output current reference of the microinverter is controlled to attempt to operate the micro inverter as close as possible to a maximum power point (e.g., maximum power point 704, shown in FIG. 7). As described in detail herein, the output current reference is controlled based on a plurality of calculated values.

At block 802, the micro inverter completes one grid cycle. In the exemplary embodiment, grid cycles occur at a frequency of 50 Hertz. Alternatively, grid cycles may have any suitable frequency. Once the grid cycle is completed, a number of values are calculated from the previous grid cycle. The calculated values are stored on an internal memory of the microcontroller. If the grid cycle performed in block 802 is the first grid cycle for the micro inverter (i.e., there are no previous grid cycles), the output current reference for the first grid cycle is a predetermined output current reference that may be stored, for example, on a memory device external to or within the microcontroller.

At block 804, a change in average input power over the two previous grid cycles is calculated, a change in average input voltage for the two previous grid cycles is calculated, a change in average input current during the two previous grid cycles is calculated, and a change in the output current reference for the two previous grid cycles is calculated. Although these values are calculated over two previous cycles in the exemplary embodiment, alternatively, these values may be calculated using any number (i.e., at least one) previous grid cycles that enables the micro inverter to function as described herein. The change in the output current reference from the previous grid cycle is also referred to herein as the change in MPPT current reference.

At block 806, a total change in average input power over the last ten grid cycles is calculated, and a total change in average input voltage over the last ten grid cycles is calculated. While ten previous grid cycles are used in an exemplary embodiment, any number of a plurality of previous grid cycles may be used in block 806.

At block 808, a slope of an input power curve, such as input power curve 702 (shown in FIG. 7) is calculated. Specifically, the slope is calculated as the change in average input power over the previous two grid cycles divided by the change in average input voltage over the previous two grid cycles. As explained above in regards to FIG. 7, if the input power curve slope is positive, the micro inverter is operating on the left side 712 of the maximum power point 704. If the input power curve slope is negative, the micro inverter is operating on the right side 722 of the maximum power point 704.

At block 812, the change in input power calculated at block 804 is compared with a power limit Pₒ. Power limit Pₒ is a predetermined percentage (e.g., 4%) of the average input power over the previous grid cycle. Alternatively, power limit Pₒ may be any quantity that enables the micro inverter to function as described herein.

In an exemplary embodiment, if the change in input power is greater than the power limit Pₒ, an MPPT step size (i.e., the value by which the output current reference is incremented or decremented) is set to a first predetermined percentage of a previous output current reference (e.g., 5% of 1 Amp (i.e., 0.05 A)) at block 814. If the change in input power is not greater than that the power limit Pₒ, the MPPT step size is set to a second predetermined percentage of the previous output current reference (e.g., 1% of 1 A (i.e., 0.01 A)) at block 816. In an alternative embodiment, the MPPT step size is set to a fixed value (as opposed to a predetermined percentage). Alternatively, the MPPT step size may be set to any value that enables the micro inverter to function as described herein.

At block 820, it is determined whether the total change in input power over the last ten grid cycles (calculated in block 806) is less than a predetermined percentage of rated microinverter power. In an exemplary embodiment, it is determined whether the total change in input power over the last ten grid cycles amounts to decrease of more than 4%. If the total change in input power over the last ten grid cycles amounts to a decrease of more than 4%, the flow proceeds to block 822, and the output current reference is decremented by the MPPT step size set in block 814 or 816. If in the change in input power for the last ten grid cycles is not a decrease of more than 4%, flow proceeds to block 824.

At block 824, it is determined whether the total change in input voltage over the last ten grid cycles (calculated in block 806) is less than a predetermined percentage of open circuit voltage. In an exemplary embodiment, it is determined whether the total change in input voltage over the last ten grid cycles amounts to decrease of more than 2%. If the total change in input voltage over the last ten grid cycles amounts to a decrease of more than 2%, the flow proceeds to block 822, and the output current reference is decremented by the MPPT step size set in block 814 or 816. If in the change in input voltage for the last ten grid cycles is not a decrease of more than 2%, the flow proceeds to block 826.

At block 826, it is determined whether the change in input power for the previous grid cycle is greater than or equal to zero. If the change in input power for the previous grid cycle is not greater than or equal to zero, the flow proceeds to block 828. If the change in input power for the previous grid cycle is greater than or equal to zero, the flow proceeds to block 830.

At block 828, it is determined whether the change in the output current reference for the previous cycle (i.e., the change in the MPPT reference) is positive. If the change in the MPPT reference is positive, the flow proceeds to block 832, and the output current reference is reduced by a predetermined percentage of the last MPPT step. In the exemplary embodiment, the predetermined percentage is 74% of the last MPPT step. For example, if in the previous grid cycle, the output current reference started at 100 mA and is incremented to 110 mA, at block 832, the output reference current would be decremented back to 102.5 mA (i.e., a reduction of 75% of the 10 mA MPPT increase during the previous grid cycle). If the change in the MPPT reference is not positive, the flow proceeds to block 834.

At block 834, it is determined whether the slope of the input power curve (calculated at block 808) is positive. If the slope of the input power curve is positive, the current operating point is to the left of the maximum power point, and the output current reference is decremented at block 836 by the MPPT step size set in block 814 or 816. If the slope of the input power curve is not positive, the current operating point is to the right of the maximum power point, and the output current reference is incremented at block 838 by the MPPT step size set in block 814 or 816. The flow then proceeds to block 840, and another grid cycle is performed.

At block 830, it is determined whether in change in input power from the previous grid cycle is positive. If the change in input power from the previous grid cycle is not positive, the flow proceeds to block 840, and the output current reference is not incremented or decremented. If the change in input power from the previous grid cycle is positive, the flow proceeds to block 842.

At block 842, it is determined whether the change in the output current reference for the previous cycle (i.e., the change in the MPPT reference) is positive. If the change in the MPPT reference is positive, the flow proceeds to block 844, and the output current reference is incremented by the MPPT step size set in block 814 or 816. If the change in the MPPT reference is not positive, the flow proceeds to block 846.

At block 846, it is determined whether the slope of the input power curve (calculated at block 808) is positive. If the slope of the input power curve is positive, the current operating point is to the left of the maximum power point, and the output current reference is decremented at block 822 by the MPPT step size set in block 814 or 816. If the slope of the input power curve is not positive, the current operating point is to the right of the maximum power point, and the output current reference is incremented at block 844 by the MPPT step size set in block 814 or 816. The flow then proceeds to block 840, and another grid cycle is performed.

The systems and methods described herein enable operating a micro inverter at or near the maximum power point. For example, in some embodiments, the algorithm shown in flow diagram 800 may have a maximum power point tracking efficiency of 99% or higher.

A technical effect of the methods and systems described herein may include one or more of: (a) calculating a change in input power over at least one previous grid cycle; (b) calculating a change in an output current reference over the at least one previous grid cycle; and (c) controlling the output current reference based on the change in input power over the at least one previous grid cycle and the change in the output current reference over the at least one previous grid cycle.

Exemplary embodiments of operating a micro inverter using maximum power point tracking are described herein. For maximum power point tracking, a microcontroller controls an output current reference of the micro inverter. The output current reference may be incremented or decremented based on at least one of a change in input voltage from a previous grid cycle, a change in input power from a previous grid cycle, and a slope of a power output curve. The output current may be incremented or decremented by an MPPT step size that is set based on a change in input power from a previous grid cycle.

The order of execution or performance of the operations in the embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for operating a micro inverter using power point tracking, said method comprising:
calculating a change in input power over at least one previous grid cycle;
calculating a change in an output current reference over the at least one previous grid cycle; and
controlling the output current reference based on the change in input power over the at least one previous grid cycle and the change in the output current reference over the at least one previous grid cycle.

2. A method in accordance with claim 1, wherein controlling the output current reference comprises:
calculating, when the change in input power over the at least one previous grid cycle is negative and the change in the output current reference over the at least one previous grid cycle is not positive, a slope of an input power curve as the change in input power over the at least one previous grid cycle divided by a change in input voltage over the at least one previous grid cycle;
decrementing the output current reference when the slope of the input power curve is positive; and
incrementing the output current reference when the slope of the input power curve is not positive.

3. A method in accordance with claim 1, wherein controlling the output current reference comprises:
calculating, when the change in input power over the at least one previous grid cycle is positive and the change in the output current reference over the at least one previous grid cycle is not positive, a slope of an input power curve as the change in input power over the at least one previous grid cycle divided by a change in input voltage over the at least one previous grid cycle;
decrementing the output current reference when the slope of the input power curve is positive; and
incrementing the output current reference when the slope of the input power curve is not positive.

4. A method in accordance with claim 1, wherein controlling the output current reference comprises:
decrementing, when the change in input power over the at least one previous grid cycle is negative and the change in the output current reference over the at least one previous grid cycle is positive, the output current reference by a predetermined percentage of the change in the output current reference over the previous grid cycle.

5. A method in accordance with claim 1, wherein controlling the output current reference comprises:
incrementing, when the change in input power over the at least one previous grid cycle is positive and the change in the output current reference over the at least one previous grid cycle is positive, the output current reference.

6. A method in accordance with claim 1, further comprising:
setting a maximum power point tracking (MPPT) step size based on the change in input power over the at least one previous grid cycle, wherein controlling the output current reference comprises at least one of incrementing the output current reference by the MPPT step size and decrementing the output current reference by the MPPT step size.

7. A method in accordance with claim 6, wherein setting an MPPT step size comprises:
setting the MPPT step size equal to a first predetermined percentage of a previous output current reference when the change in input power from the previous grid cycle is above a power limit; and
setting the MPPT step size equal to a second predetermined percentage of the previous output current reference when the change in input power from the previous grid cycle is not above the power limit.

8. A method for operating micro inverter using power point tracking, said method comprising:
calculating a total change in input power over a predetermined plurality of previous grid cycles;
calculating a total change in input voltage over the predetermined plurality of previous grid cycles; and
controlling an output current reference based on at least one of the total change in input power over the predetermined plurality of previous grid cycles and the total change in input voltage over the predetermined plurality of previous grid cycles.

9. A method in accordance with claim 8, wherein the predetermined plurality of previous grid cycles is a fixed number of previous grid cycles stored in a memory.

10. A method in accordance with claim 8, wherein controlling the output current reference comprises:
decrementing, when the total change in input power over the predetermined plurality of previous grid cycles amounts to a decrease in input power of more than a predetermined percentage, the output current reference.

11. A method in accordance with claim 8, wherein controlling the output current reference comprises:
decrementing, when the total change in input voltage over the predetermined plurality of previous grid cycles amounts to a decrease in input voltage of more than a predetermined percentage, the output current reference.

12. A method in accordance with claim 8, further comprising:
setting a maximum power point tracking (MPPT) step size based on a change in input power over the previous grid cycle, wherein controlling the output current reference comprises at least one of incrementing the output current reference by the MPPT step size and decrementing the output current reference by the MPPT step size.

13. A method in accordance with claim 12, wherein setting an MPPT step size comprises:
setting the MPPT step size equal to a first predetermined percentage of a previous output current reference when the change in input power over the previous grid cycle is above a power limit; and
setting the MPPT step size equal to a second predetermined percentage of the previous output current reference when the change in input power over the previous grid cycle is not above the power limit.

14. A micro inverter comprising:
a microcontroller configured to operate said micro inverter using power point tracking; and
a memory communicatively coupled to said microcontroller and having computer-readable instructions stored thereon, the computer-readable instructions executable by said microcontroller to instruct said microcontroller to:
calculate a change in input power over at least one previous grid cycle;
calculate a change in an output current reference over the at least one previous grid cycle; and
control the output current reference based on the change in input power over the at least one previous grid cycle and the change in the output current reference over the at least one previous grid cycle.

15. A micro inverter in accordance with claim 14, wherein to control the output current reference, the computer-readable instructions instruct said microcontroller to:
calculate, when the change in input power over the at least one previous grid cycle is negative and the change in the output current reference over the at least one previous grid cycle is not positive, a slope of an input power curve as the change in input power over the at least one previous grid cycle divided by a change in input voltage over the at least one previous grid cycle;
decrement the output current reference when the slope of the input power curve is positive; and
increment the output current reference when the slope of the input power curve is not positive.

16. A micro inverter in accordance with claim 14, wherein to control the output current reference, the computer-readable instructions instruct said microcontroller to:
calculate, when the change in input power over the at least one previous grid cycle is positive and the change in the output current reference over the at least one previous grid cycle is not positive, a slope of an input power curve as the change in input power over the at least one previous grid cycle divided by a change in input voltage over the at least one previous grid cycle;
decrement the output current reference when the slope of the input power curve is positive; and
increment the output current reference when the slope of the input power curve is not positive.

17. A micro inverter in accordance with claim 14, wherein to control the output current reference, the computer-readable instructions instruct said microcontroller to:
decrement, when the change in input power over the at least one previous grid cycle is negative and the change in the output current reference over the at least one previous grid cycle is positive, the output current reference by a predetermined percentage of the change in the output current reference over the previous grid cycle.

18. A micro inverter in accordance with claim 14, wherein to control the output current reference, the computer-readable instructions instruct said microcontroller to:
increment, when the change in input power over the at least one previous grid cycle is positive and the change in the output current reference over the at least one previous grid cycle is positive, the output current reference.

19. A micro inverter in accordance with claim 14, wherein the computer-readable instructions further instruct said microcontroller to:
set a maximum power point tracking (MPPT) step size based on the change in input power over the at least one previous grid cycle, wherein controlling the output current reference comprises at least one of incrementing the output current reference by the MPPT step size and decrementing the output current reference by the MPPT step size.

20. A micro inverter in accordance with claim 19, wherein to set an MPPT step size, the computer-readable instructions instruct said microcontroller to:
set the MPPT step size equal to a first predetermined percentage of a previous output current reference when the change in input power over the at least one previous grid cycle is above a power limit; and
set the MPPT step size equal to a second predetermined percentage of the previous output current reference when the change in input power over the at least one previous grid cycle is not above the power limit.
